(19) United States
(12) Patent Application Publication
(10) Pub. No.: US 2006/0170700 A1
(43) Pub. Date: Aug. 3, 2006

(54) Control interface

(76) Inventors: Uvom M. Hoelscher, Steinfurt (DE); Peter Uphoff, Denzlingen (DE); Bernard Hug, Freiburg (DE); Frank Frankus, Freiburg (DE)

Correspondence Address: FISH & RICHARDSON PC, P.O. BOX 1022, MINNEAPOLIS, MN, 55440-1022, US

(21) Appl. No.: 10/851,468

(22) Filed: May 24, 2004

(30) Foreign Application Priority Data
May 23, 2003 (EP) 03 011 679

(51) Int. Cl. G09G 5/02

(52) U.S. Cl. 345/597

(57) ABSTRACT

A device operator interface includes a first operational parameter display field for displaying a first adjustable parameter characterizing a first operational state of a device and displaying a first distinctive color associated with the first operational state of the device, a second operational parameter display field for displaying a second adjustable parameter characterizing a second operational state of the device and displaying a second distinctive color associated with the second operational state of the device, and a control element manually operable to change the first parameter in a first state, and manually operable to change the second parameter in a second state. A color display is associated with the control element, and the color display is configured to display the first color when the control element is in its first state and is configured to display the second color when the control element is in its second state.

### TECHNICAL FIELD

This invention relates to a device controller, and more particularly to a control interface.

### BACKGROUND

Conventional electro-surgery with radio-frequency (RF) radiation can be used for cutting or coagulating tissue with electric energy. The use of suitable electrodes permits thermal separation of the tissue and coagulation of the cut vessels, which largely eliminates bleeding in the region of the cut.

A controller for controlling the RF radiation (e.g., the RF generator for the electro-surgical application) and the operating table are usually located separately from each other. The controller need not necessarily be operated by the surgeon and can be used in a multi-functional manner (i.e., for cutting and coagulating different tissue and organs).

If only one central control element is provided, the surgeon or the assistant must operate the controller with great care and concentration to ensure that the correct function is controlled with the correct operational parameters during the operation. If only one central control element is provided to adjust different parameters, it must be associated with one of the parameters before adjustment. This association is often cancelled after adjustment to prevent inadvertent adjustment. The function of the control element can therefore assume the states of being inactive, being associated with a first parameter, and being associated with a second parameter. The status of activation and type of operation or operational mode of the control element can be difficult to recognize immediately.

When the controller is adjusted, the user (e.g., the surgeon or assistant) can first read a certain operational parameter display field, then look at the location of the control element to grasp it, and then look at the operational parameter display field while adjusting the control element without looking at the control element again until the display shows the desired setting. Because the adjustment process involves repeated changes of the direction of view, errors in adjustment can happen through confusion or misreading of the parameters.

### SUMMARY

In a first general aspect, a device operator interface includes a first operational parameter display field for displaying a first adjustable parameter characterizing a first operational state of a device and displaying a first distinctive color associated with the first operational state of the device, a second operational parameter display field for displaying a second adjustable parameter characterizing a second operational state of the device and displaying a second distinctive color associated with the second operational state of the device, and a control element manually operable to change the first parameter in a first state, and manually operable to change the second parameter in a second state. A color display is associated with the control element, and the color display is configured to display the first color when the control element is in its first state and is configured to display the second color when the control element is in its second state.

In another general aspect, a medical surgical device includes a radio frequency probe, a controller for controlling the probe, and a device operator interface. The interface includes a first operational parameter display field on the controller for displaying a first adjustable parameter characterizing a first operational state of a device and displaying a first distinctive color associated with the first operational state of the device, a second operational parameter display field on the controller for displaying a second adjustable parameter characterizing a second operational state of the device and displaying a second distinctive color associated with the second operational state of the device, and a control element on the controller manually operable to change the first parameter in a first state, and manually operable to change the second parameter in a second state. A color display is associated with the control element, and the color display is configured to display the first color when the control element is in its first state and is configured to display the second color when the control element is in its second state.

One or more of the following features may be included. For example, the control element can be a rotatable knob, and the color display can be an illuminated ring surrounding the knob. The operator interface can further include at least one light emitting diode for illuminating the illuminated ring. The color display can be configured to indicate that the interface is in neither its first nor second state. The device can be adapted to perform electro-surgical cutting and coagulation, and the device controller can be adapted for changing the device between a first operational mode for performing electro-surgical cutting and a second operational mode for performing coagulation. The first color can be associated with the first operational mode, and the second color can be associated with the second operational mode. The color display can display a third color when the control element is not associated with either the first operational state or the second operational state.

In another general aspect, a method of controlling a device includes displaying a first adjustable parameter characterizing a first operational state of the device in a first operational parameter display field of a controller of the device, displaying a first distinctive color associated with the first operational state of the device in proximity with the first display field, displaying a second adjustable parameter characterizing a second operational state of the device in a second operational parameter display field of the controller of the device, displaying a second distinctive color associated with the second operational state of the device in proximity with the second display field. When a manually operable control element of the controller is operable to change the first parameter, the first color is displayed in proximity with the control element, and when a the control element is operable to change the second parameter, the second color is displayed in proximity with the control element.

One or more of the following features may be included. The control element can be a rotatable knob, and the color display can be an illuminated ring surrounding the knob. The interface can include at least one light emitting diode for illuminating the illuminated ring. The color display can be configured to indicate that it is in neither its first nor second state. The device can be adapted to perform electro-surgical cutting and coagulation, and the device controller can be adapted for changing the device between a first operational mode for performing electro-surgical cutting and a second operational mode for performing coagulation. The first color can be associated with the first operational mode, and the second color can be associated with the second operational mode. The color display can display a third color when the control element is not associated with either the first operational state or the second operational state.

### DESCRIPTION OF DRAWINGS

FIG. 1 is a schematic front view of a control means.

FIG. 2 is schematic front view of an illuminated ring on a control element of the control means of FIG. 1.

Like reference symbols in the various drawings indicate like elements.

### DETAILED DESCRIPTION

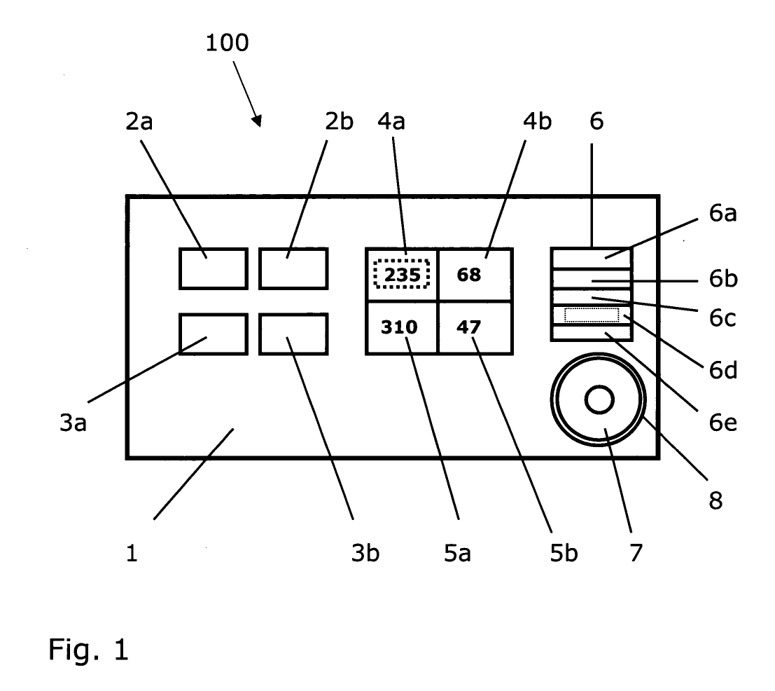

Referring to FIG. 1, a control panel 1 of a controller 100 of a device for cutting and coagulating tissue in electro-surgery includes, in addition to power connections and possible further elements (not shown in FIG. 1), control keys 2a, 2b and 3a, 3b, operational parameter display fields 4a, 4b, 5a and 5b, a program type overview 6 with program display fields 6a through 6e, and a control element in the form of a turning knob 7 including an illuminated ring 8, which is spatially separated from the display fields and control keys. For example the device can be a radio-frequency (RF) probe for performing electro-surgical cutting and coagulation. Generally, when the probe is used as a cutting device it requires higher RF power than when it is used as a coagulation device.

Parameters displayed in parameter display fields 4a, 4b, 5a and 5b relate to use of device for different operational states. The operational parameter of field 4a relates to electro-surgical cutting under fluid. The operational parameter of field 5a relates to electro-surgical cutting under gas. The operational parameter of field 4b relates to electro-surgical coagulation under fluid. The operational parameter of field 5b relates to electro-surgical coagulation under gas.

Control keys 2a, 2b, 2c, and 2d are associated with operational parameter display fields 4a, 4b, 4c, and 4d, in that actuation of a particular control key 2a, 2b, 2c, or 2d activates the associated operational parameter display 4a, 4b, 4c, or 4d and permits adjustment of the parameter that is displayed in the associated operational parameter display 4a, 4b, 4c, or 4d.

If a certain program for treating a particular body region (e.g., the thorax) is selected through activation of a program display field 6d (e.g., the dotted line in FIG. 1 indicates that a program is activated), the required operational parameters can be set in a subsequent step. Towards this end, an operational parameter display field (e.g., field 4a) is selected through the associated control key (e.g., key 2a). The value of the parameter to be set (e.g., a power of 235 W) is displayed in the parameter display field 4a. This value can be set automatically by the controller 100, but the automatically-set value can also be changed through actuation of a central turning knob 7.

Because the main operational difference in the device when used for electro-surgical cutting and coagulation is the amount of RF power supplied to the device, it is important that the user of controller 100 immediately recognizes the operational parameters that are selected or that are to be set, when he/she actuates the central turning knob 7. Towards this end, the operational state of cutting can be associated with a first color (e.g., yellow) and coagulation can associated with a second color (e.g., blue). Thus, the control keys 2a and 3a and the operational parameter display fields 4a and 5a associated with cutting can be lined with the first color (yellow) and the control keys 2b and 3b and the operational parameter display fields 4b and 5b associated with coagulation can be lined with the second color (blue). The central rotatable knob 7 is moreover surrounded by an illuminated ring 8 such that the rotatable knob 7 is illuminated in accordance with the operational parameter display fields 4a, 4b, 5a, 5b with the color that corresponds to the lining of the respective operational parameter display field. Based on the information about the association of the colors (cutting=yellow, coagulation=blue) and the illumination of the turning knob 7, the user can recognize immediately that he/she is changing the operational parameter for cutting or coagulating. The operational state of the controller 100, which is ready for adjustment and currently activated, is thereby clearly emphasized on the turning knob 7.

Thus, the currently set operational mode and/or the currently set operational state of the controller 100 are shown directly on the rotatable knob 7 in an ergonomically appropriate fashion, or the rotatable knob 7 can change its color in correspondence to currently set operational mode and/or the currently set operational state of the controller 100. The colored markings of the operational parameter display fields 4a, 4b, 5a, and 5b and the colored markings of the rotatable knob 7 are automatically linked through suitable electric and/or electronic switches, such that both locations show the same colored marking for the operational mode and/or the activated operational state of the controller 100. When the user changes the operational parameters for an operational mode and/or a certain operational state on the rotatable knob 7, the colored marking of the rotatable knob 7 also displays the operational mode and/or the operational state, which increases safety of use of the device and the controller 100. If the rotatable knob 7 is not activated, the rotatable knob 7 is not necessarily marked with a characteristic color but can have a neutral color.

When a general setting has been selected on the menu field 6, which is not directly related to any primary function (cutting and coagulating), the turning knob 7 can be illuminated with a color that is not associated with either of the colors of associated with the display fields 4a, 4b, 5a, 5b or the control keys 2a, 2b, 3a, 3b (e.g., white light).

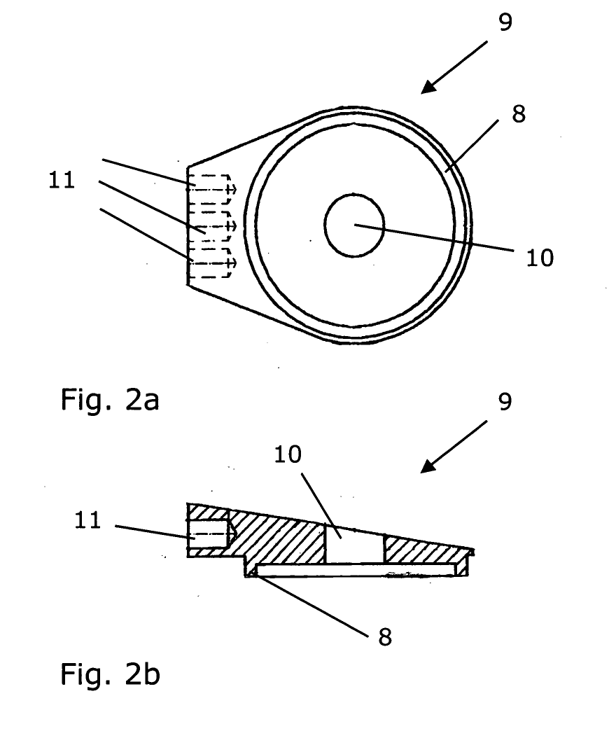

FIGS. 2a and 2b show a top view and a sectional view of a transparent holder 9 including an axis of rotation 10 for the turning knob 7 (not shown in FIG. 2), wherein three receptacles 11 are formed for three light emitting diodes that generate light of different colors. This light from the light emitting diodes shines into the holder 9 such that the illuminated ring 8 for receiving the turning knob 7 is illuminated and surrounds the turning knob 7 and ensures that the color associated with an operational mode and/or operational state is illuminated on the turning knob 7.

A number of implementations have been described. Nevertheless, it will be understood that various modifications may be made. For example, although a device controller has been explained with reference to an RF surgical generator for electro-surgical cutting and coagulation of tissue, use of the device controller in connection with any other control means in the field of medical technology as well as in other fields is also feasible. Accordingly, other implementations are within the scope of the following claims.

What is claimed is:

1. A device operator interface comprising:
a first operational parameter display field for displaying a first adjustable parameter characterizing a first operational state of a device and displaying a first distinctive color associated with the first operational state of the device;
a second operational parameter display field for displaying a second adjustable parameter characterizing a second operational state of the device and displaying a second distinctive color associated with the second operational state of the device;
a control element manually operable to change the first parameter in a first state, and manually operable to change the second parameter in a second state; and
a color display associated with the control element, wherein the color display is configured to display the first color when the control element is in its first state and is configured to display the second color when the control element is in its second state.

2. The operator interface of claim 1, wherein the control element is a rotatable knob and the color display is an illuminated ring surrounding the knob.

3. The operator interface of claim 2, further comprising at least one light emitting diode for illuminating the illuminated ring.

4. The operator interface of claim 1, wherein the color display is configured to indicate that the interface is in neither its first nor second state.

5. The operator interface of claim 1, wherein the device is adapted to perform electro-surgical cutting and coagulation, and wherein the device controller is adapted for changing the device between a first operational mode for performing electro-surgical cutting and a second operational mode for performing coagulation.

6. The operator interface of claim 5, wherein the first color is associated with the first operational mode, and the second color is associated with the second operational mode.

7. The operator interface of claim 6, wherein the color display displays a third color when the control element is not associated with either the first operational state or the second operational state.

8. A method of controlling a device, the method comprising:
displaying a first adjustable parameter characterizing a first operational state of the device in a first operational parameter display field of a controller of the device;
displaying a first distinctive color associated with the first operational state of the device in proximity with the first display field;
displaying a second adjustable parameter characterizing a second operational state of the device in a second operational parameter display field of the controller of the device;
displaying a second distinctive color associated with the second operational state of the device in proximity with the second display field;
when a manually operable control element of the controller is operable to change the first parameter, displaying the first color in proximity with the control element, and when a the control element is operable to change the second parameter, displaying the second color in proximity with the control element.

9. The method of claim 8, wherein the control element is operable to change the first of second parameter through manual rotation of the control element.

10. The method of claim 8, wherein the first color and the second color are displayed through illumination of a ring around the control element with colored light.

11. The method of claim 10, wherein the colored light is supplied by one or more light emitting diodes.

12. The method of claim 8, further comprising, when a manually operable control element of the controller neither operable to change the first parameter nor operable to change the second parameter, displaying neither the first color nor the second color in proximity with the control element.

13. The method of claim 8, wherein the device is adapted to perform electro-surgical cutting when it is in the first operational state and is adapted to perform electro-surgical coagulation when it is in the second operational state.

14. A medical surgical device comprising:
a radio frequency probe;
a controller for controlling the probe; and
a device operator interface comprising:
a first operational parameter display field on the controller for displaying a first adjustable parameter characterizing a first operational state of the probe and displaying a first distinctive color associated with the first operational state of the probe;
a second operational parameter display field on the controller for displaying a second adjustable parameter characterizing a second operational state of the probe and displaying a second distinctive color associated with the second operational state of the probe;
a control element on the controller manually operable to change the first parameter in a first state, and manually operable to change the second parameter in a second state; and
a color display associated with the control element, wherein the color display is configured to display the first color when the control element is in its first state and is configured to display the second color when the control element is in its second state.

15. The operator interface of claim 14, wherein the control element is a rotatable knob and the color display is an illuminated ring surrounding the knob.

16. The operator interface of claim 15, further comprising at least one light emitting diode for illuminating the illuminated ring.

17. The operator interface of claim 14, wherein the color display is configured to indicate that it is in neither its first nor second state.

18. The operator interface of claim 14, wherein the probe is adapted to perform electro-surgical cutting and coagulation, and wherein the controller is adapted for changing the probe between a first operational mode for performing electro-surgical cutting and a second operational mode for performing coagulation.

19. The operator interface of claim 18, wherein the first color is associated with the first operational mode, and the second color is associated with the second operational mode.

20. The operator interface of claim 19, wherein the color display displays a third color when the control element is not associated with either the first operational state or the second operational state.
